(19) United States
(12) Patent Application Publication
(10) Pub. No.: US 2025/0168207 A1
(43) Pub. Date: May 22, 2025

(54) ELECTRONIC DEVICE CAPABLE OF PROVIDING VIDEO CALL SERVICE AND CONTROL METHOD FOR SAME

(71) Applicant: SAMSUNG ELECTRONICS CO., LTD., Suwon-si (KR)

(72) Inventors: Jongin LEE, Suwon-si (KR); Sehyun KIM, Suwon-si (KR); Yongwoo SHIN, Suwon-si (KR); Kilsoo CHOI, Suwon-si (KR); Hyeeun PARK, Suwon-si (KR)

(73) Assignee: SAMSUNG ELECTRONICS CO., LTD., Suwon-si (KR)

(21) Appl. No.: 19/034,389

(22) Filed: Jan. 22, 2025

Related U.S. Application Data
(63) Continuation of application No. PCT/KR2023/008087, filed on Jun. 13, 2023.

(30) Foreign Application Priority Data
Jul. 29, 2022 (KR) 10-2022-0094972

(51) Int. Cl. H04L 65/1093; G06F 3/0481; G06F 3/0484

(52) U.S. Cl. CPC H04L 65/1093; G06F 3/0481; G06F 3/0484

(57) ABSTRACT

An electronic device capable of providing a video call service and a control method for same. The electronic device comprises a memory, a transceiver, and a processor electrically connectable to the memory and transceiver. The processor: provides a user interface in association with a video call application on a display, the user interface including a first video received from a camera, a second video received from the transceiver, and an option enabled to trigger transmission of second system information; and, based on detection of a preset triggering condition, switches the user interface which is a first user interface to a second user interface that excludes the option enabling trigger transmission. The first system information and the second system information are determined on the basis of configuration information associated with a preview representation of the video call application.

### CROSS-REFERENCE TO RELATED APPLICATIONS

This application is a continuation application of International Application No. PCT/KR2023/008087, filed on Jun. 13, 2023, in the Korean Intellectual Property Receiving Office, which claims priority from Korean Patent Application No. 10-2022-0094972, filed on Jul. 29, 2022, in the Korean Intellectual Property Office, the disclosures of which are hereby incorporated by reference herein in their entireties.

### TECHNICAL FIELD

The disclosure relates to an electronic device capable of providing a video call service and a control method for same.

### BACKGROUND ART

As wired and wireless communication networks and communication technologies develop, the use of video call services between electronic devices is increasing. Specifically, video call services between electronic devices are widely used to allow different users remotely located to perform contactless communication. Specifically, for a video call service, one electronic device and another electronic device may be connected to each other through a wired/wireless communication network. Here, the electronic device may include a display to provide a video call screen, and may be any electronic device capable of performing communication with the other electronic device remotely located by accessing the wired/wireless communication network. For example, the electronic device may include portable computers, such as laptops, netbooks or tablet PCs, portable terminals, such as smartphones or PDAs, or TVs.

If a video call is performed between a plurality of electronic devices, e.g., a first electronic device and a second electronic device, the first electronic device obtains an image for the user and transmits the obtained image to the second electronic device. Accordingly, the second electronic device may perform a call while viewing the image for the user of the first electronic device. Further, the second electronic device obtains an image for the user and transmits the obtained image to the first electronic device. Accordingly, the first electronic device may perform a call while viewing the image for the user of the second electronic device.

### DETAILED DESCRIPTION OF THE INVENTION

### Technical Problem

The disclosure provides an electronic device and a control method thereof which may prevent an intrusion of privacy while minimizing interaction between a device and a user required when using a video call service.

### Technical Solution

An electronic device according to an embodiment comprises a memory, a transceiver, and a processor electrically connectable to the memory and the transceiver. According to an embodiment, while the processor is electrically connected to the memory and the transceiver, the processor may transmit a first image obtained through a camera to another electronic device through the transceiver. According to an embodiment, the processor may provide a user interface screen in association with a video call application on a display. In an embodiment, the user interface screen may include the first image, a second image received from the transceiver, and a selectable option associated with transmission of system information to determine whether to display the transmitted first image in the other electronic device. According to an embodiment, the system information may be determined based on configuration information associated with a preview screen of the video call application. If the preview screen is configured not to be displayed, the video call application immediately shares the image obtained through the camera with the counterpart device, causing a serious invasion of privacy. On the other hand, if the preview screen is configured to be displayed, an interaction for the preview screen should be performed. Thus, significant inconvenience is caused when using a device in which interaction is not easy. According to an embodiment, it is possible to prevent an invasion of privacy due to immediate sharing of an image as well as to reduce interaction between the user and the device.

According to an embodiment, the processor may detect an input to transmit a video call participation request through the video call application. According to an embodiment, the processor may identify the configuration information associated with the preview screen based on detecting the input.

According to an embodiment, the processor may switch the first user interface screen to a second user interface screen without the selectable option based on detecting a preset triggering condition.

According to an embodiment, the processor may transmit the video call participation request to a server based on detecting the input. According to an embodiment, the video call participation request may include participant information for distinguishing the electronic device from another electronic device accessing the server.

According to an embodiment, the processor may receive the second image from the server based on the video call participation request.

According to an embodiment, the preset triggering condition may be detected based on an elapse of a preset time.

According to an embodiment, the system information may include first system information and second system information. According to an embodiment, the selectable option may be associated with transmission of any one of the first system information or the second system information. According to an embodiment, the preset triggering condition may be detected based on a user input to the selectable option.

According to an embodiment, the first system information may be identified based on configuration information configured not to display the preview screen. According to an embodiment, the second system information may be identified based on configuration information configured to display the preview screen.

According to an embodiment, the first system information may include one or more pieces of information for controlling the other electronic device not to display the first image. According to an embodiment, the first system information may include one or more pieces of information for controlling to display an icon indicating a display delay on the other electronic device. According to an embodiment, the first system information may include one or more pieces of information for controlling the other electronic device to display a third user interface screen including an icon indicating a display delay on a display instead of the first image.

According to an embodiment, the first system information may include one or more pieces of information for setting a window associated with the first image to be smaller than one or more windows associated with another image configuring the third user interface screen on the third user interface screen.

According to an embodiment, the second system information may include one or more pieces of information for controlling the other electronic device to display the first image.

According to an embodiment, the second system information may include one or more pieces of information for controlling the other electronic device to display a fourth user interface screen including the first image on a display.

An electronic device according to an embodiment comprises a memory, a transceiver, and a processor electrically coupleable to the memory and the transceiver. According to an embodiment, the processor may provide a first user interface screen of a video call application on a display. According to an embodiment, the first user interface screen may include a first image received from a camera, a second image received from the transceiver, and a selectable option associated with network transmission of the first image. According to an embodiment, the processor may initiate the network transmission based on detecting the preset triggering condition. According to an embodiment, the processor may provide a second user interface screen in association with the video call application to the display based on detecting the preset triggering condition. According to an embodiment, the second user interface screen may include the first image and the second image.

### Advantageous Effects

Electronic devices according to an embodiment of the disclosure may control the display of an image shared by the counterpart device, preventing an intrusion of the user's privacy and excluding the display of the preview screen to thereby reduce interaction between user and device.

Effects achievable in example embodiments of the disclosure are not limited to the above-mentioned effects, but other effects not mentioned may be apparently derived and understood by one of ordinary skill in the art to which example embodiments of the disclosure pertain, from the following description. In other words, unintended effects in practicing embodiments of the disclosure may also be derived by one of ordinary skill in the art from example embodiments of the disclosure.

### BRIEF DESCRIPTION OF THE DRAWINGS

FIG. 1 is a block diagram illustrating an electronic device applied to an embodiment of the disclosure;

FIG. 2 is a view exemplarily illustrating a user interface screen associated with a video call application according to an embodiment;

FIG. 3 is an exemplary block diagram illustrating a video call system according to an embodiment;

FIG. 4 is a flowchart illustrating a control method of a user device according to an embodiment;

FIG. 5 is a flowchart illustrating a control method of a user device according to an embodiment;

FIG. 6 is a flowchart illustrating a control method of a counterpart device according to an embodiment;

FIG. 7 is a flowchart illustrating a control method by a video call system according to an embodiment;

FIG. 8 illustrates an implementation example of a video call service according to an embodiment;

FIGS. 9 to 12 are views illustrating a configuration of a user interface screen based on configuration information related to a preview screen according to an embodiment; and

FIGS. 13 and 14 are views illustrating a switch between user interface screens based on a triggering condition according to an embodiment.

Reference may be made to the accompanying drawings in the following description, and specific examples that may be practiced are shown as examples within the drawings. Other examples may be utilized and structural changes may be made without departing from the scope of the various examples.

### MODE FOR CARRYING OUT THE INVENTION

Hereinafter, embodiments of the disclosure are described in detail with reference to the drawings so that those skilled in the art to which the disclosure pertains may easily practice the disclosure. However, the disclosure may be implemented in other various forms and is not limited to the embodiments set forth herein. The same or similar reference denotations may be used to refer to the same or similar elements throughout the specification and the drawings. Further, for clarity and brevity, no description is made of well-known functions and configurations in the drawings and relevant descriptions.

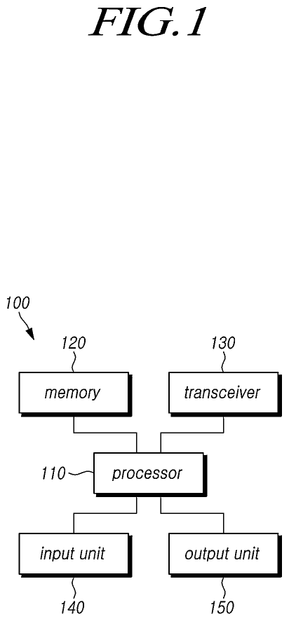

FIG. 1 is a block diagram illustrating an electronic device applied to an embodiment of the disclosure.

An electronic device according to an embodiment of the disclosure may include a processor, a memory, and a transceiver. According to an embodiment, the electronic device may include at least one of an input unit and an output unit.

According to an embodiment, the one or more processors 110 may include a storage and processing circuit unit for supporting the operation of the electronic device. The storage and processing circuit unit may include storage, such as non-volatile memory (e.g., flash memory, or other electrically programmable ROM configured to form a solid state drive (SSD)) or volatile memory (e.g., static or dynamic RAM). The processing circuit unit in the processor may be used to control the operation of the electronic device 100. The processing circuit unit may be based on one or more microprocessor(s), microcontroller(s), digital signal processor(s), baseband processor(s), power management section(s), audio chip(s), or application specific integrated circuit(s). The transceiver and memory described below are an embodiment of the processor and may be provided as functional elements performing specific functions or operations as at least part of the processor or as separate hardware components as entities performing independent functions or operations.

According to an embodiment, one or more memories 120 may include a memory area for one or more processors for storing variables used in the protocol, configuration, control, and other functions of the device, including operations corresponding to or including any one of the methods and/or procedures described as an example in the disclosure. Further, the memory may include non-volatile memory, volatile memory, or a combination thereof. Moreover, the memory may interface with a memory slot that enables insertion and removal of removable memory cards in one or more formats (e.g., SD card, memory stick, compact flash, etc.).

According to an embodiment, the transceiver 130 may include a wired communication module, a wireless communication module or an RF module. The wireless communication module may include, for example, Wi-Fi, BT, GPS or NFC. For example, the wireless communication module may provide a wireless communication function using a radio frequency. The transceiver 130 may include a network interface or modem for connecting the device 100 with a network (e.g., Internet, LAN, WAN, telecommunication network, cellular network, satellite network, POTS or 5G network). The RF module may be responsible for data transmission/reception, e.g., transmitting and receiving data RF signals or invoked electronic signals. As an example, the RF module may include, e.g., a power amp module (PAM), a frequency filter, or a low noise amplifier (LNA). Additionally, the RF module may further include parts (e.g., conductors or wires) for communicating radio waves in a free space upon performing wireless communication.

The input unit is an electronic module or an electronic device for receiving the user's input. The input unit may convert the user's input into an electrical signal and provide it to another system component such as a memory or a processor. The input unit may include, e.g., a keypad, a button, a touch pad, or a touch screen, but is not limited thereto.

According to an embodiment, the input unit may receive a control signal from a remote control device. For example, the remote control device may transmit a control signal (e.g., an optical signal) toward the electronic device, and the electronic device may identify the control signal. If the control signal is identified, the electronic device may perform a subsequent operation after the identification.

For example, the TV device may be powered on in response to identifying the control signal.

For example, the TV device may identify the movement of the linked remote control device. A virtual cursor displayed on the TV device may also move in response to the movement of the linked remote control device. Further, if the control signal received from the remote control device is received, a selection input may be received to the location of the virtual cursor currently displayed on the display of the TV device. If the selection input is received, an option or icon corresponding to the received location may be activated. For example, if an execution icon of an application exists at the received location, the associated application may be executed as a selection input for the corresponding icon is received.

According to an embodiment, the input unit may include an A/V input unit for receiving an A/V input. The A/V input unit may provide an image or audio signal of an external device to the device according to an embodiment of the disclosure. For example, the A/V input unit may include, but is not limited to, a USB terminal, a composite video banking sync (CVBS) terminal, a component terminal, an S-video terminal (analog), a digital visual interface (DVI) terminal, a high definition multimedia interface (HDMI) terminal, an RGB terminal, and a D-SUB terminal.

According to an embodiment, the output unit may include a sound output unit and a display unit.

According to an embodiment, the sound output unit is an electronic module or an electronic device for outputting sound such as voice and music. According to an embodiment, the sound output unit may receive audio data from a peripheral device interface. The sound output unit may convert the received audio data into sound waves and output the same to the outside of the device. The sound output unit may include, e.g., a receiver, a speaker, a buzzer, or the like, but is not limited thereto.

According to an embodiment, the display unit is an electronic module or an electronic device for outputting a video or an image. The display unit includes, e.g., a single display panel or a multi-display panel. If a single display panel is provided, the device may output one display screen. If a multi-display panel is provided, the device may output an integrated screen in a form in which outputs of two or more display panels are combined. According to an embodiment, even if the single display panel is provided, a plurality of windows may be included in one output screen, and thus one output is not limited to one window. According to an embodiment, the multi-display panel may be provided in, e.g., a TV device, a monitor device, an MR device, an AR device, or a VR device. In an implementation, if provided in an MR device, an AR device, or a VR device, the multi-display panel may provide MR, AR, or VR content to each eye.

According to an embodiment, one or more display units are configured to present a user interface. In an implementation, one or more display units correspond to holographic, digital light processing (DLP), liquid crystal display (LCD), liquid crystal on silicon (LcoS), organic light emitting transistor (OLET), organic light emitting diode (OLED), surface-conduction electron-emitter display (SED), field emission display (FED), quantum dot light emitting diode (QD-LED), micro-electromechanical system (MEMS), or similar display types. In an implementation, one or more display units correspond to waveguide displays such as diffraction, reflection, polarization, and holography.

According to an embodiment, each of the one or more processors 110, one or more memories 120, one or more transceivers 130, one or more input units 140, and one or more output units 150 may be interconnected by one or more buses. According to an embodiment, the one or more buses may include a circuit unit that interconnects or controls communication between system components.

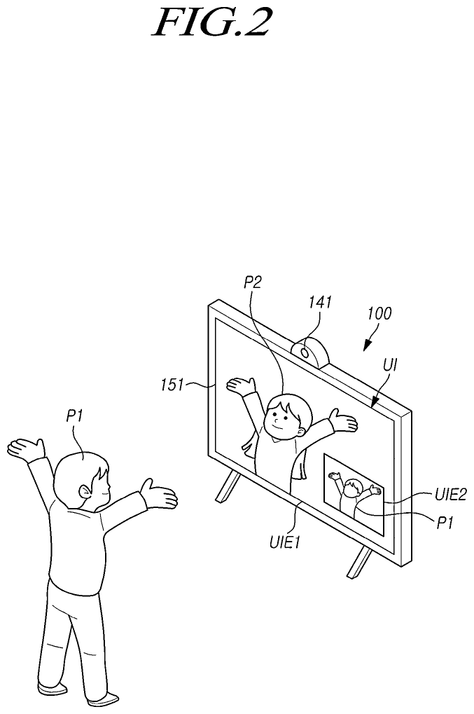

FIG. 2 is a view exemplarily illustrating a user interface screen associated with a video call application.

According to an embodiment, a video call application may be stored in the memory of the electronic device (100 of FIG. 1). The video call application may support transmitting and receiving an image and voice with another remote person. The electronic device may display an image provided from the counterpart device on the display 151 using the video call application. Further, the electronic device may provide a voice provided from the counterpart device through a speaker using the video call application. As such, the video call application provides a voice and image, so that the user may have a conversation closer to the real one than the voice call.

According to an embodiment, the user interface screen UI associated with the video call application may be displayed on the display 151 of the electronic device. According to an embodiment, the user interface screen UI may include a plurality of screen elements. Some of the plurality of screen elements may be represented to be included on a preset window.

According to an embodiment, the user interface screen UI may include a first screen element UIE1 and a second screen element UIE2. The first screen element UIE1 may be represented on the first window, and the second screen element UIE2 may be represented on the second window. The second window may be configured as at least a partial area of the first window, but is not limited thereto. The second window may be configured to have a size smaller than that of the first window. The second window may be represented to overlap the first window. For example, the second screen element UIE2 may be represented on the second window, and the second window may be displayed to overlap the first window, e.g., in a picture-in-picture (PIP) manner.

For example, the first screen element UIE1 provided from the counterpart device may be displayed on the first window. For example, the second screen element UIE2 obtained by the electronic device may be represented on the second window. The first screen element UIE1 may include an image of the second person P2 positioned in front of the counterpart device. The second screen element UIE2 may include an image of the first person P1 positioned in front of the electronic device. The second screen element UIE2 may be obtained by the camera 141 provided in the electronic device. The camera 141 may provide the obtained image to a processor and/or memory to be electrically connected.

In the disclosure, the term “first electronic device” refers to the electronic device of the first person P1, and the term “Nth electronic device (where N is a natural number of 2 or more)” refers to the electronic device of the Nth person. In the disclosure, the first electronic device may be referred to as a “user device” and the Nth electronic device may be referred to as a “counterpart device”.

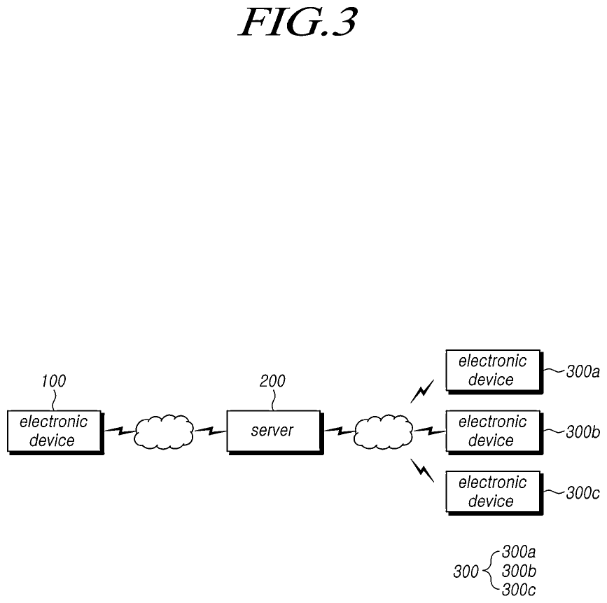

FIG. 3 is an exemplary block diagram illustrating a video call system according to an embodiment.

Referring to FIG. 3, a system according to an embodiment may include a user device 100, a server 200, and a counterpart device 300. According to an embodiment, the user device 100, the server 200, and the counterpart device 300 may each be wirelessly connected through a network. According to an embodiment, the user device 100 and the counterpart device 300 may transmit an image and voice for a video call to the server 200. According to an embodiment, the server 200 may transmit an image and voice received from the user device 100 and the counterpart devices 300 to the user device 100 and the counterpart devices 300.

According to an embodiment, the server 200 may identify the user device 100 and the counterpart devices 300 participating in the video call through the video call application. The server 200 may identify the user device 100 and the counterpart device 300 participating in a specific video call, and receive the image and voice from the identified devices. The server 200 may transmit the image and voice received from the devices to the user device 100 and the counterpart device 300 participating in the specific video call. Accordingly, all of the electronic devices participating in the specific video call may output a voice and image obtained from each of the devices to the display unit or the sound output unit.

FIG. 3 illustrates that the counterpart device 300 includes the first to third counterpart devices 300a, 300b, and 300c, but embodiments of the disclosure are not limited thereto.

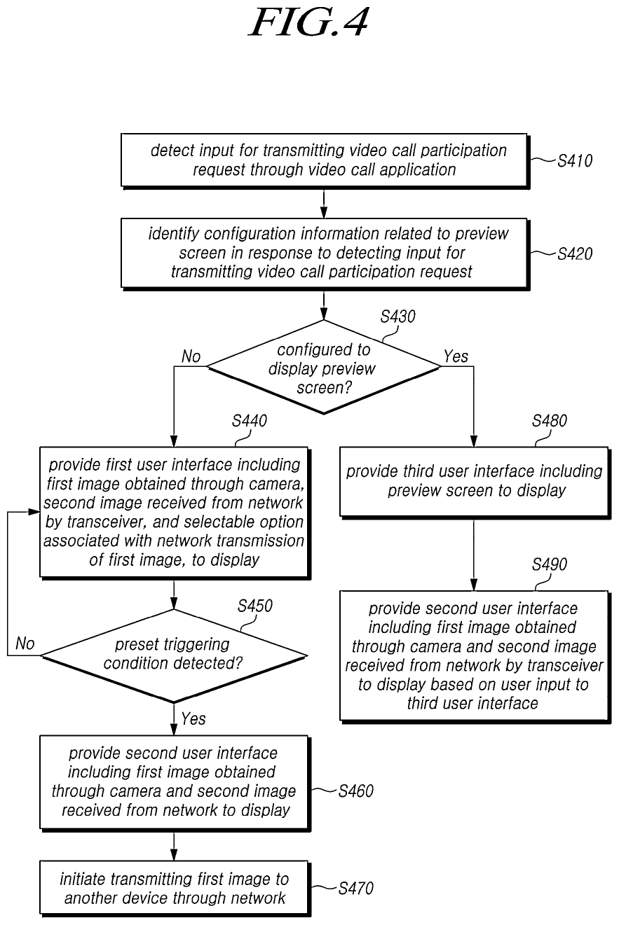

FIG. 4 is a flowchart illustrating a control method of a user device according to an embodiment.

Referring to FIG. 4, the user device according to an embodiment may perform the following control method. The control method according to an embodiment may perform at least some of the plurality of operations exemplified by S410 to S470. The control method according to an embodiment is not limited to operations S410 to S470, and at least part of each operation may be replaced by an alternative operation, or may further include an additional operation in the middle.

According to an embodiment, the user device may detect an input for transmitting a video call participation request through the video call application (S410).

According to an embodiment, the video call application may be stored in the memory of the user device. The video call application may be executed by the processor.

According to an embodiment, the user device may detect an input for transmitting a video call participation request through the input unit. According to an embodiment, the user device may detect an input for transmitting a video call participation request through the transceiver.

According to an embodiment, the user device may identify configuration information related to the preview screen in response to detecting an input for transmitting a video call participation request (S420). According to an embodiment, the user device may identify an electrical signal related to receiving an input for transmitting the video call participation request. The user device may identify configuration information related to the preview screen in response to identifying the electrical signal. The preview screen of the disclosure is one of screens associated with the video call application. The preview screen may include one or more icons for setting input/output of an image or voice to be provided through the video call application. The input/output settings of the video call application may be changed based on one or more user inputs to the preview screen.

For example, the preview screen may pre-display the image obtained through the camera on the display before sharing the image obtained through the camera with the counterpart device. The user may look at the preview screen while adjusting the state of the image to be transmitted to the counterpart device or organizing the surrounding environment included in the field of view (FoV) range of the camera. Further, the user may adjust the angle of view of the camera to prevent an intrusion of privacy, and the preview screen may include a GUI for adjusting the angle of view of the camera.

For example, the preview screen may pre-output the voice obtained through the speaker before sharing the voice obtained through the microphone with the counterpart device. The user may input his or her voice through a microphone while the preview screen is displayed, and may listen to his or her voice to be output from the counterpart device in advance through the sound output unit. Accordingly, it is possible to prevent the counterpart party of the video call from experiencing inconvenience due to the state of the microphone after the video call is started.

According to an embodiment, the video call application may include configuration information associated with the preview screen. According to an embodiment, the user device may determine whether to display the preview screen based on the preview screen and configuration information.

According to an embodiment, the configuration information associated with the preview screen may include first configuration information and second configuration information. If the configuration information associated with the preview screen is identified as the first configuration information, the user device may determine to display the preview screen. If the configuration information associated with the preview screen is identified as the second configuration information, the user device may determine not to display the preview screen.

According to an embodiment, if the preview screen is not identified as being displayed, the user device may provide a first user interface screen including a first image obtained through the camera, a second image received by the transceiver, and a selectable option associated with network transmission of the first image to the display (S430: No, S440).

According to an embodiment, the user device may obtain the first image through the camera. The first image may include an image of a first person (e.g., the user) positioned in front of the user device. According to an embodiment, the user device may receive an image of a second person (e.g., the counterpart party) from the counterpart device (e.g., a server or the counterpart device) through the transceiver. The second image may include the image of the second person (e.g., the counterpart) who makes the video call with the first person.

According to an embodiment, the user device may transmit the first image obtained through the camera to another device in response to detecting a triggering condition to be described below in S450. In this case, the first user interface screen may include a selectable option associated with network transmission of the first image. The user device may be configured to transmit or not transmit the first image to another device (e.g., a server or the counterpart device) according to whether the user input to the selectable option is received.

According to an embodiment, the user device may transmit the first image to the other device in response to providing the first user interface screen, or may transmit the first image to the other device in response to receiving the second image from the other device. In this case, the first user interface screen may include a selectable option associated with transmission of the system information. The user device may be configured to transmit or not to transmit system information to the other device (e.g., a server or the counterpart device) according to whether the user input to the selectable option is received.

According to an embodiment, the system information is information for setting the display state of the first image in the counterpart device. According to an embodiment, the system information may include first system information and second system information. According to an embodiment, the user device may control the counterpart device not to display the first image by transmitting the first system information together with the first image. According to an embodiment, the user device may transmit the first system information so that the counterpart device displays a preset icon instead of the first image. According to an embodiment, the user device may transmit the second system information together with the first image so that the counterpart device displays the first image. The counterpart device may display the first image in response to receiving the second system information.

According to an embodiment, the user device may detect a preset triggering condition (S450).

According to an embodiment, the triggering condition may be a preset time condition. According to an embodiment, the user device may detect the triggering condition in response to reaching a preset time. For example, if the preset time is 3 minutes, the user device may provide the first user interface screen for 3 minutes and then switch the first user interface screen to the second user interface screen, which is described below in S460.

According to an embodiment, the triggering condition may be configured to receive the user input to the selectable option. For example, the user input to the selectable option may be received while the first user interface screen is displayed on the display of the user device. The user device may determine that the triggering condition has been detected in response to receiving the user input to the selectable option.

According to an embodiment, as the user input to the selectable option is received, the triggering condition may be detected regardless of the detection of the preset time condition. For example, if the preset time is three minutes, the user device may provide the first user interface screen for three minutes and then switch to the second user interface screen, but if the user input to the selectable option is received before reaching the three minutes, it may be switched to the second user interface screen regardless of the time condition.

According to an embodiment, the triggering condition may be a preset gesture condition. According to an embodiment, the user device may detect the triggering condition in response to detecting a preset gesture. According to an embodiment, the gesture may be identified by analyzing the first image obtained by the camera of the user device. For example, the user device may identify a preset gesture condition based on at least one of the hand shape or hand movement of the person included in the first image. For example, if it is identified that the shape of a circle is made with the thumb and index finger, the user device may determine that the gesture condition is detected. According to an embodiment, the gesture may be identified based on a pre-trained machine learning model, but is not limited thereto.

According to an embodiment, the user device may provide a second user interface screen including a first image obtained through the camera and a second image received from the network by the transceiver to the display in response to detecting a preset triggering condition (S450: Yes, S460). According to an embodiment, if a preset triggering condition is not detected, the user device may continuously provide the first user interface screen to the display (S450: No, S440).

According to an embodiment, the user device may initiate transmitting the first image to the other device (e.g., a server or the counterpart device) through the network (S470).

According to an embodiment, the user device may transmit the first image to another device through the network in response to detecting the preset triggering condition. In this case, the user device may maintain a state in which the first image is not transmitted through the network until the triggering condition is detected. The user device may not transmit the first image regardless of transmission of the voice until the triggering condition is detected. Since the counterpart device may not receive the first image, the window in which the first image is to be displayed may be replaced with a preset icon. The counterpart may identify that the user device is not transmitting the first image through the icon.

According to an embodiment, the user device may transmit the second system information to the other device in response to detecting a preset triggering condition. In this case, the user device may transmit the first image to the other device through the network even before the triggering condition is detected. For example, the user device may transmit the first image to the other device in response to providing the first user interface screen, or may transmit the first image to the other device in response to receiving the second image from the other device. The first image transmitted to the counterpart device may or may not be displayed based on the type of system information transmitted to the counterpart device. For example, if the first system information is transmitted, the first image may not be displayed on the counterpart device, and if the second system information is transmitted, the first image may be displayed on the counterpart device.

According to an embodiment, operation S470 is not limited to being performed after operation S460, but may be performed before, after, or simultaneously with operation S470. For example, operation S460 and operation S470 may be performed in response to detecting the triggering condition. For example, S460 and S470 may be sequentially performed in response to detecting the triggering condition. For example, S470 and S460 may be sequentially performed in response to detecting the triggering condition.

According to an embodiment, if it is identified that the preview screen is displayed, the user device may provide a third user interface screen including the preview screen to the display (S430: Yes, S480).

According to an embodiment, the third user interface screen may include the preview screen as at least a portion thereof. For example, the preview screen may pre-display the image obtained through the camera on the display before sharing the image obtained through the camera with the counterpart device. The user may look at the preview screen while adjusting the state of the image to be transmitted to the counterpart device or organizing the surrounding environment included in the field of view (FoV) range of the camera. Further, the user may adjust the angle of view of the camera to prevent an intrusion of privacy, and the preview screen may include a GUI for adjusting the angle of view of the camera. For example, the preview screen may pre-output the voice obtained through the speaker before sharing the voice obtained through the microphone with the counterpart device. The user may input his or her voice through a microphone while the preview screen is displayed, and may listen to his or her voice to be output from the counterpart device in advance through the sound output unit. Accordingly, it is possible to prevent the counterpart party of the video call from experiencing inconvenience due to the state of the microphone after the video call is started.

Although not limited thereto, according to an embodiment, the third user interface screen may be configured to receive the user input only in an area corresponding to the preview screen. For example, even if a user input is applied to the rest of the area except for the area corresponding to the preview screen, the user device may not perform an interaction-based operation. For example, only if the user input is applied to an area corresponding to the preview screen, the user device may perform an interaction-based operation.

According to an embodiment, the user device may switch the third user interface screen to the second user interface screen in response to receiving the user input to the third user interface screen (S490).

According to an embodiment, the user device may switch the third user interface screen to the second user interface screen in response to receiving the user input to the preview screen. The second user interface screen may be configured not to include the preview screen. For example, the second user interface screen may include the first image obtained through the camera and the second image received from the network by the transceiver.

According to an embodiment of the disclosure, the user device may transmit either the first image or the second system information to the other electronic device based on a preset triggering condition. According to an embodiment, if configured to transmit the first image, the user device does not transmit the first image to the other device until a triggering condition is detected. According to an embodiment, if configured to transmit the second system information, the user device may transmit the first image to the other device regardless of the triggering condition.

Further, according to an embodiment, although not limited thereto, voice may be transmitted to the other electronic device along with the first image being transmitted to the other electronic device.

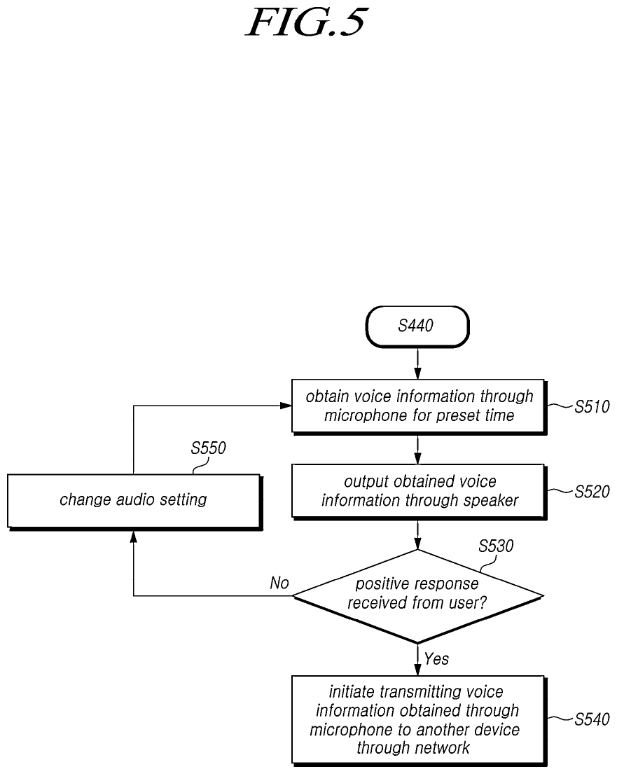

FIG. 5 is a flowchart illustrating a control method of a user device according to an embodiment.

Referring to FIG. 5, the user device according to an embodiment may perform the following control method. The control method according to an embodiment may perform at least some of the plurality of operations exemplified by S510 to S550. The control method according to an embodiment is not limited to operations S510 to S550, and at least part of each operation may be replaced by an alternative operation, or may further include an additional operation in the middle.

According to an embodiment, the user device may obtain a user voice through the microphone for a preset time (S510).

According to an embodiment, the preset time may be set to be shorter than a preset time of the time condition among the above-described triggering conditions in S440. For example, if the triggering condition is 3 minutes, the time to obtain the user voice may be set to 10 seconds. The voice obtained through the microphone may be stored in the memory of the user device.

According to an embodiment, the user device may output the obtained voice through the speaker (S520).

According to an embodiment, the user device may output the obtained voice through the speaker for a predetermined time. For example, the user device may output the voice obtained through the speaker in response to completing the voice acquisition of S510. Through this, the user may listen to in advance how his or her voice input through his or her device will sound to the counterpart party.

According to an embodiment, the user device may receive a response to the voice output from the user (S530).

The user device may receive a positive response or a negative response. The positive response is a response to provide voice to the other device based on the current audio setting (e.g., the setting of the microphone). The negative response is a response to change the current audio setting to another audio setting or to display a setting window for changing.

According to an embodiment, if the positive response is received, the user device may initiate transmitting the voice obtained through the microphone to the other device through the network (S530: Yes, S540).

According to an embodiment, if the negative response is received, the user device may change the audio setting without transmitting the voice obtained through the microphone to the other device through the network (S530: Yes, S550).

According to an embodiment, the negative response may include a first negative response and a second negative response. The user device may increase the volume of the voice to be output from the counterpart device based on receiving the first negative response. The user device may reduce the magnitude of the voice to be output from the counterpart device based on receiving the second negative response.

According to an embodiment, the user device may display a setting window for changing the audio setting on the display in response to receiving a negative response. The user may change the audio setting using the setting window. The user device may increase or decrease the volume of the voice to be output from the counterpart device based on the user input to the setting window.

If the preview screen is excluded, the user may not know or adjust his or her voice state to be output to the counterpart party in advance. According to an embodiment, it is possible to check the user's voice condition by obtaining and outputting voice for a portion of the total time (e.g., if the first image is not transmitted to the network, or before the second system information is transmitted) if the image is not displayed to the counterpart device.

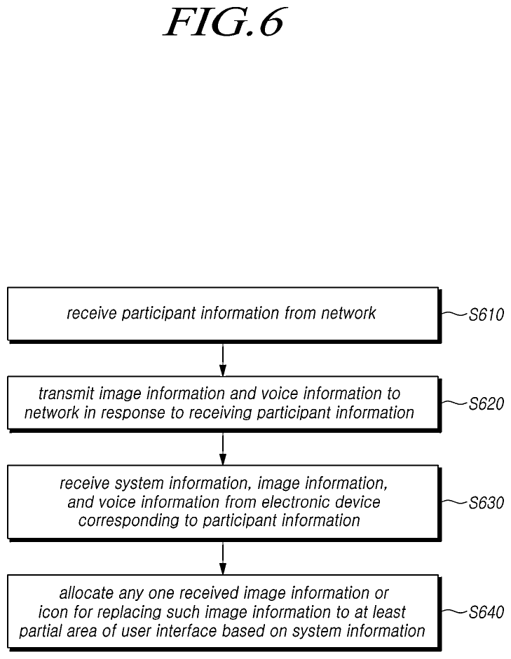

FIG. 6 is a flowchart illustrating a control method of a counterpart device according to an embodiment.

Referring to FIG. 6, a counterpart device according to an embodiment may perform the following control method. The control method according to an embodiment may perform at least some of a plurality of operations exemplified by S610 to S640. The control method according to an embodiment is not limited to operations S610 to S640, and at least part of each operation may be replaced by an alternative operation, or may further include an additional operation in the middle. According to an embodiment, operations performed by the counterpart device may also be performed by the user device. For example, if the user device receives an image or voice from a counterpart device capable of implementing the control method of FIG. 4 and/or FIG. 5, the user device may perform one or more operations illustrated in FIG. 6.

According to an embodiment, the counterpart device may receive participant information from the network (S610).

According to an embodiment, the participant information may be received from a server. The server may transmit the participant information to the counterpart device in response to receiving a video call participation request. The video call participation request may include participant information for identifying the requesting user device. The server may transmit participant information to the counterpart device so that the counterpart device may identify the user device that has transmitted the participation request.

According to an embodiment, the counterpart device may transmit the image and voice to the network in response to receiving the participant information (S620).

According to an embodiment, the counterpart device may transmit the image and voice to the network based on participant information. The counterpart device may transmit a voice and image to the server so that an electronic device (e.g., the user device) associated with the participant information receives the image and voice.

According to an embodiment, the counterpart device may receive at least one of system information, an image, and a voice from the electronic device corresponding to the participant information (S630).

According to an embodiment, the counterpart device may receive the image and voice from the electronic device (e.g., the user device) associated with the participant information. According to an embodiment, the counterpart device may store the received image and voice in the memory.

According to an embodiment, the counterpart device may display the received image on at least a portion of the user interface screen of the video call application.

According to an embodiment, the counterpart device stores the received image in the memory, but may determine whether to output the image based on the system information. According to an embodiment, the system information may include first system information and second system information, which have been described with reference to FIG. 4, and thus no duplicate description is given.

According to an embodiment, the counterpart device may allocate at least one of the received image or an icon for replacing the image to at least a partial area of the user interface screen based on the system information (S640).

According to an embodiment, if the counterpart device receives the first system information, the counterpart device may not display the received image on the display. According to an embodiment, the counterpart device may output the received voice but not the received image. According to an embodiment, if the counterpart device does not output the received image, the counterpart device may display the icon replacing the received image on the window where the received image is supposed to be output on the user interface screen.

According to an embodiment, if receiving the second system information, the counterpart device may display the received image on the display. According to an embodiment, the counterpart device may output the received voice through the speaker while displaying the received image on the display.

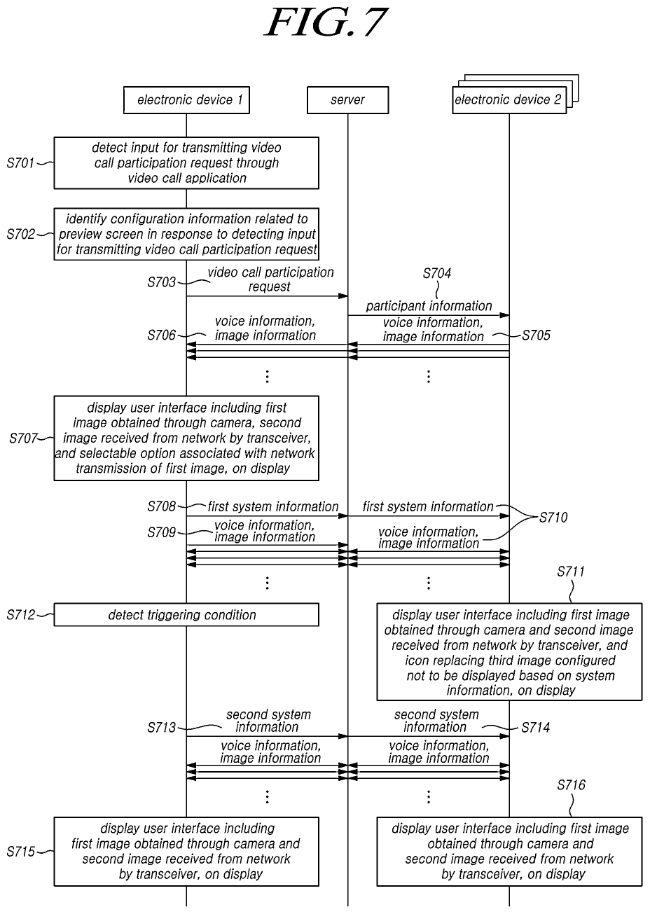

FIG. 7 is a flowchart illustrating a control method by a video call system according to an embodiment.

Referring to FIG. 7, a counterpart device according to an embodiment may perform the following control method. The control method according to an embodiment may perform at least some of the plurality of operations exemplified by S701 to S716. The control method according to an embodiment is not limited to operations S701 to S716, and at least part of each operation may be replaced by an alternative operation, or may further include an additional operation in the middle.

According to an embodiment, operations performed by the counterpart device (e.g., electronic device 2) may also be performed by the user device (e.g., electronic device 1). Conversely, operations performed by the user device (e.g., electronic device 1) may also be performed by the counterpart device (e.g., electronic device 2). The “electronic device 1” illustrated in FIG. 7 may be referred to as a first electronic device, and the “electronic device 2” may be referred to as a second electronic device.

According to an embodiment, the first electronic device may detect an input for transmitting a video call participation request through a video call application (S701). According to an embodiment, the input may be a user input. The user input may be received from the remote control device or may be input by a button provided on one side of the electronic device, but is not limited thereto.

According to an embodiment, the first electronic device may identify configuration information related to the preview screen in response to detecting the input for transmitting the video call participation request (S702). According to an embodiment, the configuration information associated with the preview screen may be understood with reference to S420 and S430 of FIG. 4. If the video call application is configured not to display the preview screen, the first electronic device may limit image display in the second electronic device based on the triggering condition in the subsequent operation. However, if the video call application is configured to display the preview screen, the first electronic device may not limit image display of the second electronic device based on the triggering condition in the subsequent operation.

According to an embodiment, if the configuration information related to the preview screen is configured to display the preview screen, it is described with reference to S480 (S430, Yes) of FIG. 4, and the following operation is described as the case where the configuration information related to the preview screen is configured to not display the preview screen.

According to an embodiment, the first electronic device may transmit a video call participation request to the server (S703).

According to an embodiment, the server may transmit the participant information to the second electronic device in response to receiving the video call participation request (S704).

According to an embodiment, the second electronic device may transmit the voice and image to the server (S705).

According to an embodiment, the server may transmit the voice and image received from the second electronic device to the first electronic device (S705).

According to an embodiment, the first electronic device may display a user interface screen including an image (first image) obtained through the camera, an image (second image) received from a server by the transceiver, and a selectable option on the display (S707).

According to an embodiment, the selectable option may be associated with network transmission of the first image obtained through the camera. According to an embodiment, the selectable option may be associated with transmission of the second system information.

According to an embodiment, if the selectable option is associated with network transmission of the first image, the first electronic device does not transmit the image until the triggering condition is detected. According to an embodiment, if the selectable option is associated with transmission of the second system information, the first electronic device may transmit the first image to the server regardless of the triggering condition.

According to an embodiment, the first electronic device may transmit the first system information to the server (S708).

According to an embodiment, the electronic device may transmit the voice and image to the server (S709).

According to an embodiment, operation S709 may be performed before operation S708. According to an embodiment, operation S709 may be performed simultaneously with operation S708. According to an embodiment, operation S709 may be performed after operation S708.

According to an embodiment, the server may transmit the first system information, the voice, and the image received from the first electronic device to the second electronic device (S710).

According to an embodiment, the second electronic device may display a user interface screen including an image (first image) obtained through the camera and an image (second image) received from the server by the transceiver on the display (S711).

According to an embodiment, at least a portion of the second image that is the basis of the user interface screen may be set as a third image based on the system information. For example, if the second electronic device receives the first system information, the second electronic device may identify the electronic device (e.g., the first electronic device) that has transmitted the first system information based on the participant information. According to an embodiment, the second electronic device may select a third image not to be displayed on the user interface screen from the second image received by the transceiver based on the first system information. Accordingly, the user interface screen of the second electronic device may include a first image obtained through the camera, a second image obtained by the transceiver and configured to be displayed based on the second system information, and a third image obtained by the transceiver but configured not to be displayed based on the first system information.

According to an embodiment, the first electronic device may detect a triggering condition (S712).

According to an embodiment, the first electronic device may transmit the second system information to the server based on detecting the triggering condition (S713).

According to an embodiment, the server may transmit the second system information to the second electronic device (S714). Here, the second system information may be received from the first electronic device.

According to an embodiment, the first electronic device may display a user interface screen including a first image obtained through the camera and a second image received by the transceiver on the display based on detecting the triggering condition (S715). Based on detecting the triggering condition, the selectable option previously included in the user interface screen may be excluded.

According to an embodiment, the second electronic device may display a user interface screen including a first image obtained through the camera and a second image received by the transceiver on the display based on receiving the second system information (S716). In this case, the configuration of the user interface screen may be equivalent to the configuration of the user interface screen in the first electronic device.

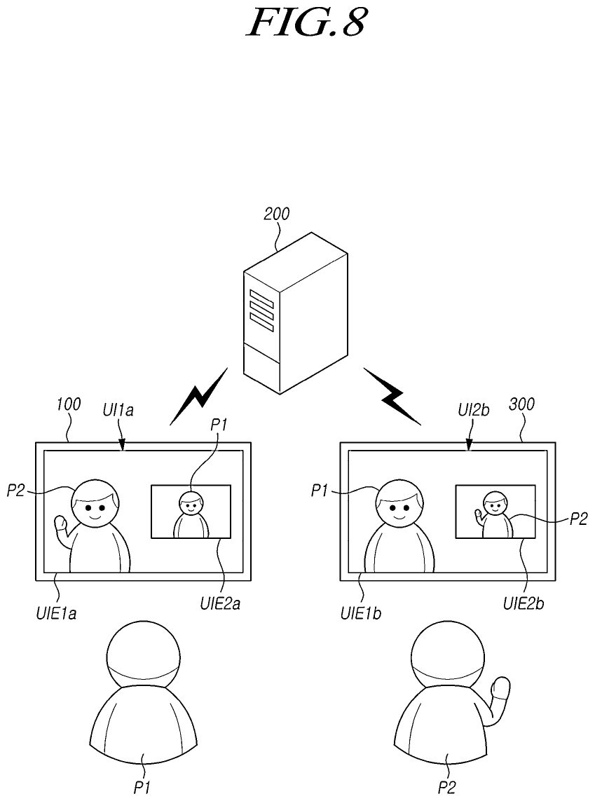

FIG. 8 illustrates an implementation example of a video call service.

According to an embodiment, a video call system may include the user device 100, a counterpart device 300, and a server 200. The user device 100 and the counterpart device 300 may be wiredly or wirelessly connected to the server 200. The user device 100 and the counterpart device 300 may support a video call service using the server 200.

According to an embodiment, the user device 100 may display a user interface screen UI1a on the display. The user interface screen UI1a may include a plurality of screen elements. The user interface screen UI1a may include a plurality of windows. The plurality of screen elements UIE1a and UIE2a may be represented on the windows. For example, the user interface screen UI1a may include a 1-1th window and a 1-2th window. The 1-1th window may display a screen element UIE1a including a second person P2 on the display. The 1-2th window may display a screen element UIE2a including a first person P1 on the display.

According to an embodiment, the screen element UIE2a including the first person P1 may be obtained using an electrically connected camera. According to an embodiment, the screen element UIE1a including the second person P2 may be obtained using an electrically connected transceiver. The screen element UIE1a including the second person P2 may be provided from the counterpart device 300.

According to an embodiment, the user device 300 may display the user interface screen UI2b on the display. The user interface screen UI2b may include a plurality of screen elements. The user interface screen UI2b may include a plurality of windows. The plurality of screen elements may be represented on the windows. For example, the user interface screen UI2b may include a 2-1th window and a 2-2th window. The 2-1th window may display a screen element UIE1b including a first person P1 on the display. The 2-2th window may display a screen element UIE2b including a second person P2 on the display.

According to an embodiment, the screen element UIE2b including the second person P2 may be obtained using an electrically connected camera. According to an embodiment, the screen element UIE1b including the first person P1 may be obtained using an electrically connected transceiver. The screen element UIE1b including the first person P1 may be provided from the user device 100.

According to an embodiment, the 1-1th window may be formed to be larger than the 1-2th window. According to an embodiment, the 2-1th window may be formed to be larger than the 2-2th window.

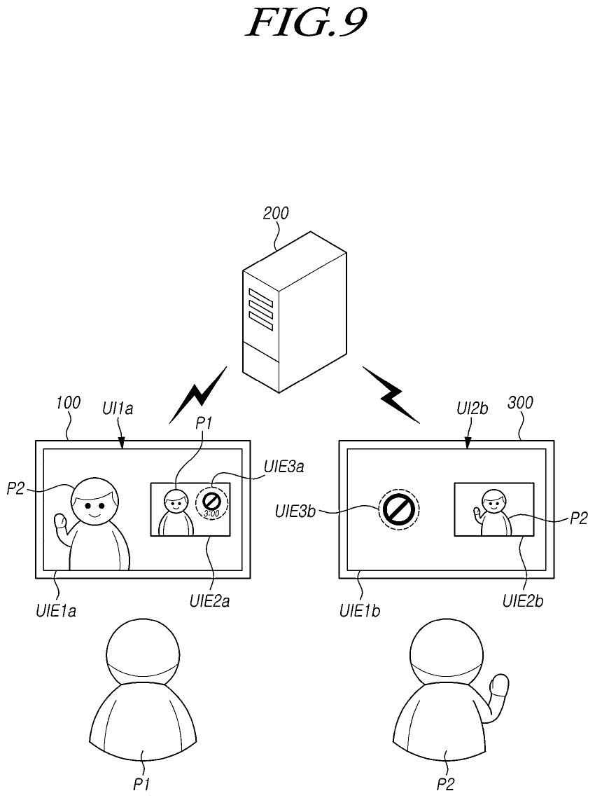

FIGS. 9 to 12 are views illustrating a configuration of a user interface screen based on configuration information related to a preview screen.

Referring to FIGS. 4 to 7, the user interface screens UI1a and UI2b may be switched based on configuration information related to the preview screen.

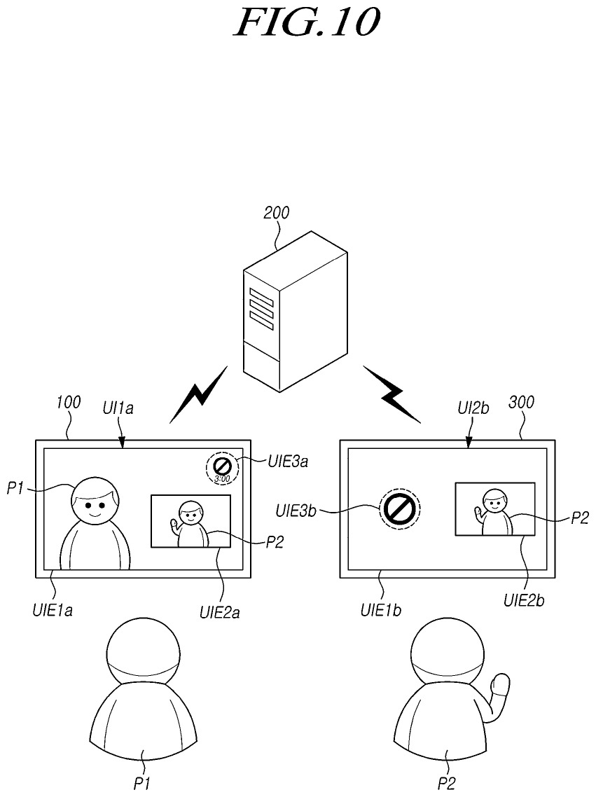

Referring to FIGS. 9 and 10, the user interface screen UI1a of the user device 100 may further include a selectable option. The selectable option UIE3a may be provided in the form of an icon. According to an embodiment, the selectable option UIE3a may be configured to further include text (e.g., “3:00”) at an adjacent location.

Referring to FIG. 9, according to an embodiment, when it is identified that the preview screen is not displayed based on the configuration information related to the preview screen, the user device 100 may change the screen element UIE2a of the 1-2th window while maintaining the screen element UIE1a of the 1-1th window. According to an embodiment, the user device 100 may further include a selectable option UIE3a as the screen element UIE2a of the 1-2th window.

Referring to FIG. 10, according to an embodiment, when it is identified that the preview screen is not displayed based on the configuration information related to the preview screen, the user device 100 may change both the screen element UIE1a of the 1-1th window and the screen element UIE2a of the 1-2th window. According to an embodiment, the user device 100 may switch and display the screen element UIE1a displayed on the 1-1th window and the screen element UIE2a displayed on the 1-2th window. Accordingly, the user may predict and prevent an intrusion of privacy by identifying the image captured by the camera of the user device 100 on a large screen.

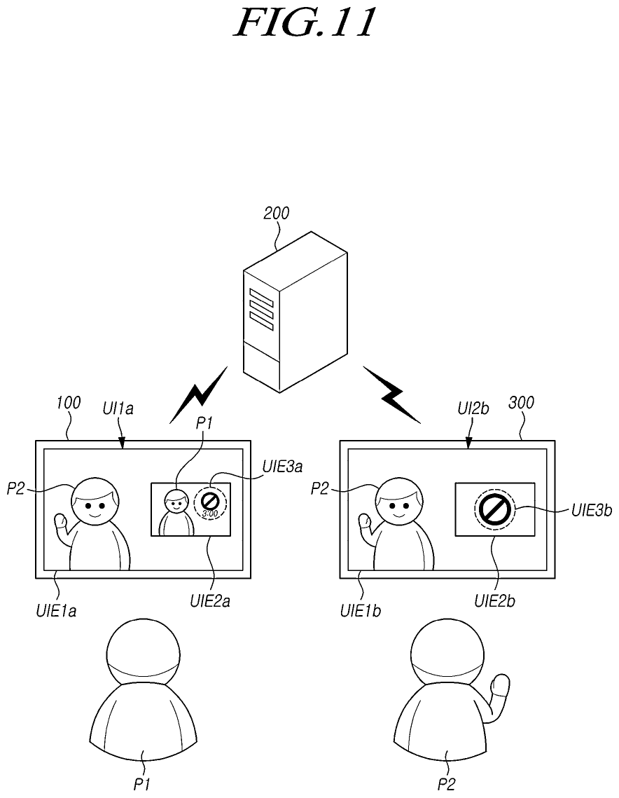

Referring to FIGS. 9 and 11, the image provided from the user device 100 may not be displayed on the user interface screen UI2b of the counterpart device 300. The counterpart device 300 may display a preset icon UIE3b instead of the image provided from the user device 100.

Referring to FIG. 9, according to an embodiment, if an image is not provided from the user device 100 or the first system information is received, the counterpart device 300 may display a non-display icon UIE3b as the screen element UIE1b of the 2-1th window while maintaining the screen element UIE2b of the 2-2th window.

Referring to FIG. 10, according to an embodiment, if an image is not provided from the user device 100 or first system information is received, the counterpart device 300 may switch the screen elements UIE1b and UIE2b of the 2-1th window and the 2-2th window. According to an embodiment, the counterpart device 300 may switch and display the screen element UIE1b displayed on the 2-1th window and the screen element UIE2b displayed on the 2-2th window. Accordingly, the counterpart may check his or her condition by identifying the image captured by the camera of the counterpart device 300 on a large screen.

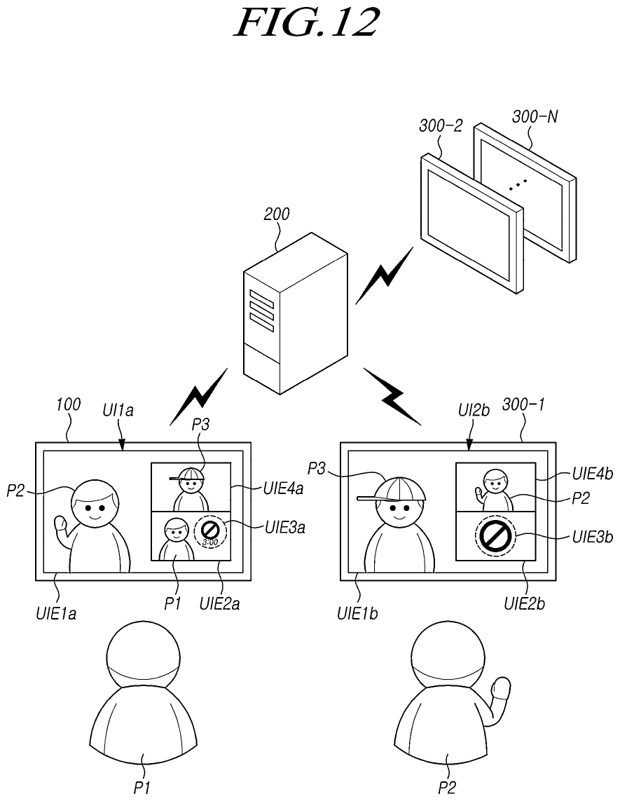

FIG. 12 is a view exemplarily illustrating a three-party video call service.

Referring to FIG. 12, the user device 100 may perform a video call with a first counterpart device 300 (e.g., 300-1) and a second counterpart device 300 (e.g., 300-2) using a server 200. An example in which the user device 100 is configured not to display a preview screen based on configuration information related to the preview screen is described.

According to an embodiment, a user interface screen in which the 1-1th window includes a 1-1th screen element UIE1a, the 1-2th window includes a 1-2th screen element UIE2a, and the 1-3th window includes a 1-3th screen element UIE4a may be displayed.

According to an embodiment, the user device 100 may further include a 1-3th window (a window representing the screen element UIE4a, an additional window) as compared to the user interface screen UI1a of the embodiment illustrated in FIG. 9. The additional window may increase in proportion to the number of participants in the video call. According to an embodiment, the screen element UIE1a displayed on the 1-1th window of the user device 100 may be selected as any one of an image including the second person P2 and an image including the third person. According to an embodiment, the user device 100 may represent any one of an image provided from the first counterpart device 300 or the image provided from the second counterpart device 300 as a screen element on the 1-1th window based on the magnitude of the voice provided from the first counterpart device 300 or the second counterpart device 300 or the order of the voice.

According to an embodiment, the image captured by the user device 100 may be represented as a screen element UIE2a, UIE4a of any one of the 1-2th window or the 1-3th window.

Hereinafter, the user interface screen of the counterpart device 300 is described.

According to an embodiment, a user interface screen in which the 2-1th window includes a 2-1th screen element UIE1b, the 2-2th window includes a 2-2th screen element UIE2b, and the 2-3th window includes a 2-3th screen element UIE4b may be displayed.

According to an embodiment, the first counterpart device 300 may further include a 2-3th window (a window representing the screen element UIE4b, an additional window) as compared to the user interface screen UI1b of the embodiment illustrated in FIG. 11. The additional window may increase in proportion to the number of participants in the video call.

According to an embodiment, the image of the user device 100 that does not transmit an image or has transmitted the first system information may be displayed on the 2-2th window or the 2-3th window. According to an embodiment, the screen element UIE1b represented on the 2-1th window of the first counterpart device 300 may be selected as any one of an image including the second person P2 or an image including the third person.

According to an embodiment, the first counterpart device 300 may represent any one of an image provided from the first counterpart device 300 or the image provided from the second counterpart device 300 as a screen element UIE1b on the 2-1th window based on the magnitude of the voice provided from the first counterpart device 300 or the second counterpart device 300 or the order of the voice. According to an embodiment, the image provided from the second counterpart device 300 may have the higher priority as the screen element UIE1b for the 2-1th window than the image provided from the first counterpart device 300.

According to an embodiment, the 1-1th window may be formed to be larger than the 1-2th window and the 1-3th window. According to an embodiment, the 2-1th window may be formed to be larger than the 2-2th window and the 2-3th window.

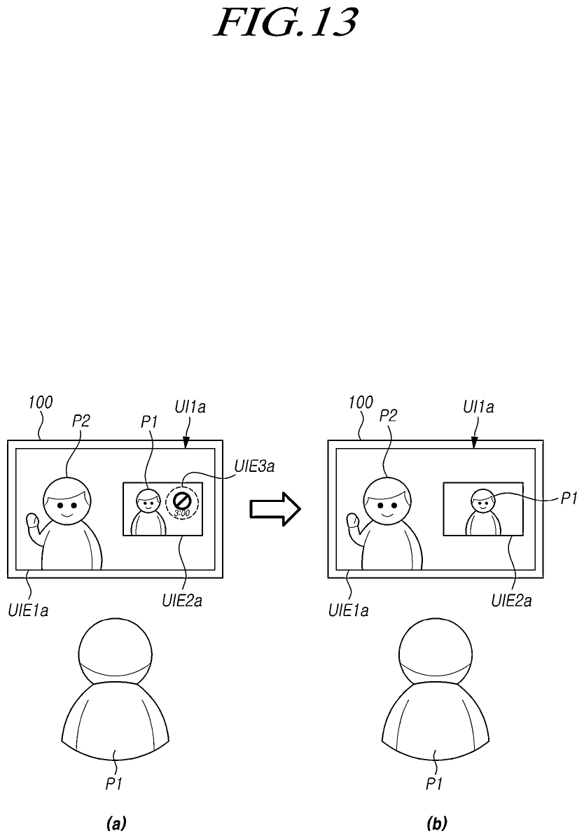

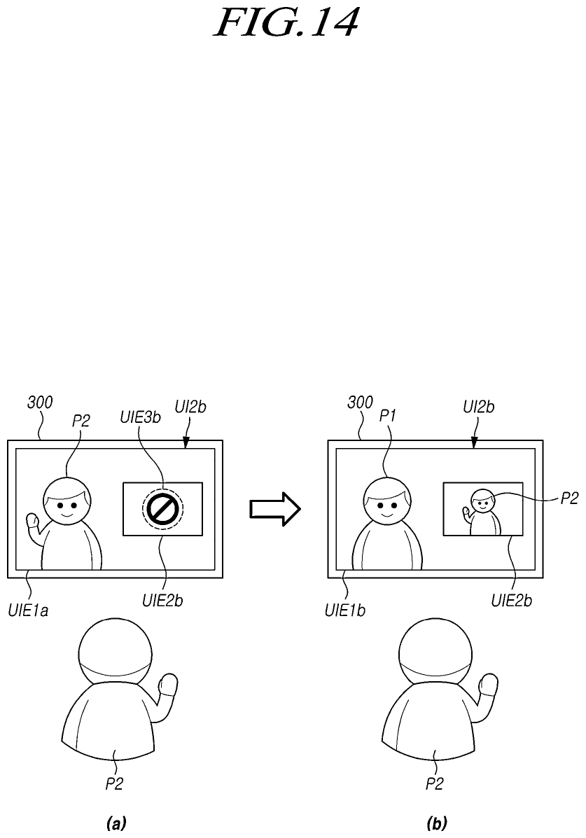

FIGS. 13 and 14 are views illustrating a switch of a user interface screen UI1a based on a triggering condition.

Referring to FIG. 13, according to an embodiment, the user device 100 may display a user interface screen UI1a including a first image obtained through the camera, a second image received from the network by the transceiver, and a selectable option UIE3a on the display until before a triggering condition is detected.

According to an embodiment, the user device 100 may display a user interface screen UI1a including the first image obtained through the camera and the second image received from the network by the transceiver on the display in response to detecting a preset triggering condition. The selectable option UIE3a may be excluded from the user interface screen UI1a displayed based on detecting the triggering condition. For example, if the predetermined triggering condition is 3 minutes, a selectable option UIE3a may be excluded from the user interface screen UI1a in response to an elapse of three minutes.

Referring to FIG. 14, according to an embodiment, the counterpart device 300 may display a user interface screen UI2b including a first image obtained through the camera and an icon associated with a second image configured not to be displayed on the display until before a triggering condition of the user device 100 is detected.

According to an embodiment, the counterpart device 300 may display a user interface screen UI2b including a first image obtained through the camera and a second image configured to be displayed on the display based on detecting the triggering condition.

According to an embodiment, the user device 100 may transmit the image obtained through the camera to the counterpart device 300 based on detecting the triggering condition. Before an image is received from the user device 100, the counterpart device 300 may output the user interface screen UI2b including the image obtained through the camera and an icon indicating that an image from the user device 100 is not received on the display. Thereafter, in response to receiving an image from the user device 100, the image obtained through the camera and the image received from the user device 100 may be output to the display on the user interface screen UI2b.

According to an embodiment, the user device 100 may transmit the second system information (refer to FIGS. 4 and 7) to the counterpart device 300 based on detecting the triggering condition. According to an embodiment, the user device 100 may transmit an image obtained through the camera to the counterpart device 300 regardless of the triggering condition. According to an embodiment, the user device 100 may transmit the first system information to the counterpart device 300 before the triggering condition is detected, and transmit the second system information to the counterpart device 300 in response to detecting the triggering condition. According to an embodiment, in response to receiving the second system information, the counterpart device 300 may display a user interface screen UI2b including the image obtained through the camera and the image received from the user device 100 on the display. In this case, the icon which is being displayed in place of the image received from the user device 100 may be removed.

The electronic device according to various embodiments of the disclosure may be one of various types of electronic devices. The electronic devices may include, for example, a display device, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. As used herein, the singular forms “a,” “an,” and “the” are intended to include the plural forms as well, unless the context clearly indicates otherwise. As used herein, the term “and/or” should be understood as encompassing any and all possible combinations by one or more of the enumerated items. As used herein, the terms “include,” “have,” and “comprise” are used merely to designate the presence of the feature, component, part, or a combination thereof described herein, but use of the term does not exclude the likelihood of presence or adding one or more other features, components, parts, or combinations thereof. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order).

As used herein, the term “part” or “module” may include a unit implemented in hardware, software, or firmware, and may interchangeably be used with other terms, for example, “logic,” “logic block,” “part,” or “circuitry”. A part or module may be a single integral component, or a minimum unit or part thereof, adapted to perform one or more functions. For example, according to an embodiment, ‘part’ or ‘module’ may be implemented in a form of an application-specific integrated circuit (ASIC).

As used in various embodiments of the disclosure, the term “if” may be interpreted as “when,” “upon,” “in response to determining,” or “in response to detecting,” depending on the context. Similarly, “if A is determined” or “if A is detected” may be interpreted as “upon determining A” or “in response to determining A”, or “upon detecting A” or “in response to detecting A”, depending on the context.

The program executed by the electronic device 100, 200, or 300 described herein may be implemented as a hardware component, a software component, and/or a combination thereof. The program may be executed by any system capable of executing computer readable instructions.

The software may include computer programs, codes, instructions, or combinations of one or more thereof and may configure the processing device as it is operated as desired or may instruct the processing device independently or collectively. The software may be implemented as a computer program including instructions stored in computer-readable storage media. The computer-readable storage media may include, e.g., magnetic storage media (e.g., read-only memory (ROM), random-access memory (RAM), floppy disk, hard disk, etc.) and an optically readable media (e.g., CD-ROM or digital versatile disc (DVD). Further, the computer-readable storage media may be distributed to computer systems connected via a network, and computer-readable codes may be stored and executed in a distributed manner. The computer program may be distributed (e.g., downloaded or uploaded) via an application store (e.g., Play Store™), directly between two UEs (e.g., smartphones), or online. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. Some of the plurality of entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

1. An electronic device, comprising:
a memory;
a transceiver; and
a processor electrically connectable to the memory and the transceiver, wherein while the processor is electrically connected to the memory and the transceiver, the processor is configured to:
transmit a first image obtained through a camera to another electronic device through the transceiver, and
provide a user interface screen in association with a video call application on a display, the user interface screen including the first image, a second image received from the transceiver, and a selectable option associated with transmission of system information to determine whether to display the transmitted first image in the other electronic device, and
wherein the system information is determined based on configuration information associated with a preview screen of the video call application.

2. The electronic device of claim 1, wherein the processor is configured to:
detect an input to transmit a video call participation request through the video call application; and
identify the configuration information associated with the preview screen based on detecting the input.

3. The electronic device of claim 2, wherein the user interface screen is a first user interface screen and the processor is configured to switch the first user interface screen to a second user interface screen without the selectable option based on detecting a preset triggering condition.

4. The electronic device of claim 2, wherein the processor is configured to transmit the video call participation request to a server based on detecting the input, and the video call participation request includes participant information to distinguish the electronic device from another electronic device accessing the server.

5. The electronic device of claim 2, wherein the processor is configured to receive the second image from a server based on the video call participation request.

6. The electronic device of claim 3, wherein the preset triggering condition is detected based on whether a preset time has elapsed.

7. The electronic device of claim 3, wherein the system information includes first system information and second system information,
wherein the selectable option is associated with transmission of any one of the first system information or the second system information, and
wherein the preset triggering condition is detected based on a user input related to the selectable option.

8. The electronic device of claim 7, wherein the first system information is identified based on configuration information configured not to display the preview screen, and
wherein the second system information is identified based on configuration information configured to display the preview screen.

9. The electronic device of claim 7, wherein the first system information includes one or more pieces of information for controlling the other electronic device not to display the first image.

10. The electronic device of claim 7, wherein the first system information includes one or more pieces of information for controlling to display an icon indicating a display delay on the other electronic device.

11. The electronic device of claim 7, wherein the first system information includes one or more pieces of information for controlling the other electronic device to display a third user interface screen including an icon indicating a display delay instead of the first image.

12. The electronic device of claim 11, wherein the first system information includes one or more pieces of information for setting a window associated with the first image to be smaller than one or more windows associated with another image configuring the third user interface screen on the third user interface screen.

13. The electronic device of claim 7, wherein the second system information includes one or more pieces of information for controlling the other electronic device to display the first image.

14. The electronic device of claim 7, wherein the second system information includes one or more pieces of information for controlling the other electronic device to display a fourth user interface screen including the first image on a display.

15. An electronic device, comprising:
a memory;
a transceiver; and
a processor electrically coupleable to the memory and the transceiver, wherein while the processor is electrically connected to the memory and the transceiver, the processor is configured to:
provide a first user interface screen in association with a video call application on a display, the first user interface screen including a first image received from a camera, a second image received from the transceiver, and a selectable option associated with network transmission of the first image; and
based on detecting a preset triggering condition, initiate the network transmission and provide a second user interface screen in association with the video call application to the display, wherein the second user interface screen includes the first image and the second image.

16. The electronic device of claim 15, wherein the preset triggering condition is detected based on whether a preset time has elapsed.

17. The electronic device of claim 15, wherein the preset triggering condition is detected based on a user input related to the selectable option.

18. The electronic device of claim 15, wherein the selectable option includes one or more pieces of information for controlling other electronic device not to display the first image.

19. The electronic device of claim 15, wherein the selectable option includes one or more pieces of information for controlling to display an icon indicating a display delay on other electronic device.
